(19) United States
(12) Patent Application Publication
(10) Pub. No.: US 2026/0154641 A1
(43) Pub. Date: Jun. 4, 2026

(54) WORKFLOW-BASED FAAS PLATFORM FOR MULTI-EVENT PROCESSING AND SERVICE PROVISION APPARATUS AND METHOD THEREFOR

(71) Applicant: FOUNDATION OF SOONGSIL UNIVERSITY INDUSTRY COOPERATION, Seoul (KR)

(72) Inventors: Young Han KIM, Seoul (KR); Jang Won SEO, Seoul (KR)

(73) Assignee: FOUNDATION OF SOONGSIL UNIVERSITY INDUSTRY COOPERATION, Seoul (KR)

(21) Appl. No.: 19/365,519

(22) Filed: Oct. 22, 2025

(30) Foreign Application Priority Data
Oct. 30, 2024 (KR) 10-2024-0150312
Nov. 11, 2024 (KR) 10-2024-0159086

(51) Int. Cl. G06Q 10/0633; G06F 9/54

(52) U.S. Cl. CPC G06Q 10/0633; G06F 9/542

(57) ABSTRACT

A workflow-based FaaS (Function as a Service) platform for multi-event processing, as well as a service-providing apparatus and method therefor. A Function as a Service (FaaS) platform for multi-event processing based on Kubernetes comprises an event-driven framework configured to detect events input from a mobile network and events input from a cloud, and to determine whether a combination of subscribed multiple events satisfies a preset condition; a workflow configured to execute a series of functions for performing one of an action, waiting, and restarting according to the combination of the multiple events when the combination of the multiple events satisfies the preset condition; and a state storage configured to store, based on identification information of an event consumer subscribing to a predetermined event, one of information about detection of the predetermined event, information about completion of a predetermined function execution, information about execution of a predetermined function in the workflow, and information about abnormal termination of a predetermined function in the workflow.

### TECHNICAL FIELD

The present invention relates to a workflow-based Function as a Service (FaaS)

platform for multi-event processing, and to an apparatus and method for providing such a service.

### BACKGROUND ART

Kubernetes is an open-source container orchestration platform that automates many of the manual processes involved in deploying, managing, and scaling containerized applications.

In a Kubernetes environment, events generated from various sources—such as those occurring in a mobile network like a 5G network (e.g., events from a Network API)—may be combined with events occurring in a general cloud environment to provide more personalized services tailored to specific situations.

To achieve this, a platform capable of detecting events and executing services is required, and such a platform should include functionality for processing multiple events. Depending on the service to be provided, the combinations and conditions of

multiple accepted events vary, and programming capabilities are required to implement the corresponding logic.

At this time, if all the code for determining event combinations and conditions and performing corresponding actions is implemented in a single application, the application can execute its logic quickly when invoked.

FIG. 1 illustrates a conventional multi-event processing method. As shown in FIG. 1, conventional multi-event processing combines an event-driven framework for detecting multiple events with multi-event processing applications (Consumers A through C).

When an event detected through the event-driven framework is consumed by a multi-event processing application, the application determines the event combination through the logic programmed within it and performs a specific task or publishes an event related to the multi-event process.

Here, “publishing” refers to defining the workflow of tasks—i.e., setting up a complex sequence of tasks, including the order of execution, whether tasks run serially or in parallel, and dependency settings.

This approach is intuitive and fast because it performs programmed actions for event patterns already defined within the application. All event pattern logic can be implemented within a single application, or each application can be designed with different logic based on its respective event pattern.

However, because this approach integrates event combinations, condition determinations, and actions within a single multi-event processing application, a new application must be created whenever new event combinations require new actions. Moreover, due to the coupling and dependencies among the logic defined in existing applications, components cannot be reused independently—resulting in additional development burdens when modifications are needed.

Accordingly, there is a need for a programmable, scalable, and reusable multi-event processing method that allows developers to freely program and design services according to their specific requirements.

### DISCLOSURE

### Technical Problem

To solve the problems of the prior art described above, the present invention proposes a FaaS platform for multi-event processing and a method thereof, which have the advantages of reusability and programmability.

### Technical Solution

According to one embodiment of the present invention, a Function as a Service (FaaS) platform for multi-event processing based on Kubernetes comprises an event-driven framework configured to detect events input from a mobile network and events input from a cloud, and to determine whether a combination of subscribed multiple events satisfies a preset condition; a workflow configured to execute a series of functions for performing one of an action, waiting, and restarting according to the combination of the multiple events when the combination of the multiple events satisfies the preset condition; and a state storage configured to store, based on identification information of an event consumer subscribing to a predetermined event, one of information about detection of the predetermined event, information about completion of a predetermined function execution, information about execution of a predetermined function in the workflow, and information about abnormal termination of a predetermined function in the workflow.

The event-driven framework may comprise an event source for each event configured to detect and convert the event into a CloudEvents format and deliver it; an event bus configured to deliver the event input to the event source to an event consumer; and an event processing service configured to determine whether a plurality of subscribed events delivered from the event bus satisfies a preset condition and to execute a predetermined function within the workflow.

The event may comprise a change in a location of a user device, a change in network status, or whether a predetermined task is completed.

The condition may comprise whether the multiple events are detected sequentially or in parallel, and the order of detection.

When a subscribed event is changed or an event detection order is changed, functions within the workflow may be modified according to the changed event and detection order.

A timeout is set for waiting in a predetermined function of the workflow, and the predetermined function may be restarted when a next event is detected within the preset timeout period.

According to another embodiment of the present invention, a Function as a Service (FaaS) apparatus for multi-event processing based on Kubernetes comprises a processor and a memory connected to the processor, wherein the memory stores program instructions executed by the processor to detect events input from a mobile network and events input from a cloud, determine whether a combination of subscribed multiple events satisfies a preset condition, execute a series of functions for performing one of an action, waiting, and restarting according to the combination of multiple events when the combination of multiple events satisfies the preset condition, and store, based on identification information of an event consumer subscribing to a predetermined event, one of information about detection of the predetermined event, information about completion of a predetermined function execution, information about execution of a predetermined function in the workflow, and information about abnormal termination of a predetermined function in the workflow.

According to yet another embodiment of the present invention, a method for providing a Function as a Service (FaaS) service for multi-event processing based on Kubernetes comprises detecting, by an event-driven framework, events input from a mobile network and events input from a cloud, and determining whether a combination of subscribed multiple events satisfies a preset condition; executing, by a workflow, a series of functions for performing one of an action, waiting, and restarting according to

the combination of multiple events when the combination of multiple events satisfies the preset condition; and storing, by a storage, based on identification information of an event consumer subscribing to a predetermined event, one of information about detection of the predetermined event, information about completion of a predetermined function execution, information about execution of a predetermined function in the workflow, and information about abnormal termination of a predetermined function in the workflow.

### Advantageous Effects

According to the present invention, when programming logic for processing not only single events but also combinations of multiple events, it is only necessary to create and add separate task logic, thereby reducing the burden of system updates and maintenance.

In addition, since previously developed task logic can be used for processing other event combinations, reusability is improved, and integration with the event-driven framework enhances the scalability and responsiveness of the workflow.

Furthermore, according to the present invention, since a service provider only needs to individually program event processing conditions and functions and can configure the workflow according to the provider's (developer's) intention, the entry barrier is lowered compared to conventional systems, and function reusability can be increased.

Additionally, because a Kubernetes-based event processing framework and workflow system are used, declarative event publishing, subscription, workflow configuration, and updating are possible, and the life cycles of the corresponding components are automatically managed, thereby reducing the system administrator's burden.

### DESCRIPTION OF DRAWINGS

These and/or other aspects will become apparent and more readily appreciated from the following description of the embodiments, taken in conjunction with the accompanying drawings, in which:

FIG. 1 is a diagram illustrating a multi-event processing method according to the prior art.

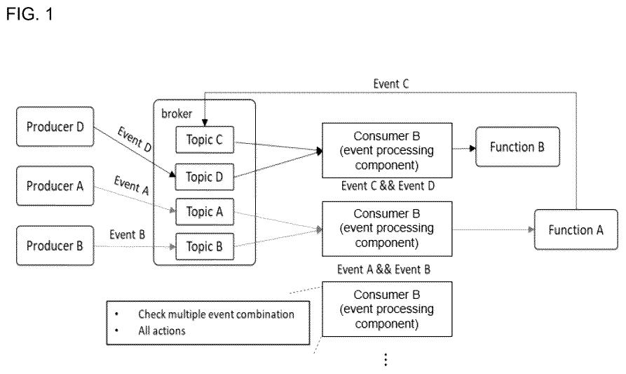

FIG. 2 is a diagram illustrating a FaaS platform for multi-event processing according to an embodiment of the present invention.

FIG. 3 is a diagram illustrating a first scenario according to an embodiment of the present invention.

FIG. 4 is a diagram illustrating a second scenario according to an embodiment of the present invention.

FIG. 5 is a diagram illustrating a third scenario according to an embodiment of the present invention.

FIG. 6 is a diagram, by way of example, illustrating a case in which a timeout is set and a predetermined function fails to complete within the set timeout according to an embodiment of the present invention.

FIG. 7 is a diagram exemplarily illustrating a case in which execution is restarted from a predetermined task within an interrupted workflow.

### DETAILED DESCRIPTION OF EMBODIMENTS

The present invention may be modified in various ways and may have several embodiments. Certain embodiments are illustrated in the drawings and will be described in detail in the specification. However, this is not intended to limit the present invention to specific embodiments, and it should be understood to include all modifications, equivalents, and alternatives that fall within the spirit and scope of the invention.

The terminology used in this specification is for the purpose of describing particular embodiments only and is not intended to limit the invention. The singular forms used herein are intended to include the plural forms as well, unless the context clearly indicates otherwise. In this specification, terms such as “comprise” or “have” are intended to specify the presence of stated features, numbers, steps, operations, components, parts, or combinations thereof, but do not preclude the possibility of the presence or addition of one or more other features, numbers, steps, operations, components, parts, or combinations thereof.

In addition, the components of the embodiments described with reference to the accompanying drawings are not limited to the specific embodiments and may be implemented or included in other embodiments within the scope of the technical spirit of the present invention. Furthermore, it is to be understood that, even if not separately described, multiple embodiments may naturally be integrated into a single embodiment.

Also, in the description with reference to the accompanying drawings, the same or corresponding reference numerals are used to denote the same or related components regardless of the figure numbers, and redundant descriptions thereof will be omitted. In the description of the present invention, detailed explanations of known technologies related to the invention will be omitted when it is deemed that such details would unnecessarily obscure the gist of the invention.

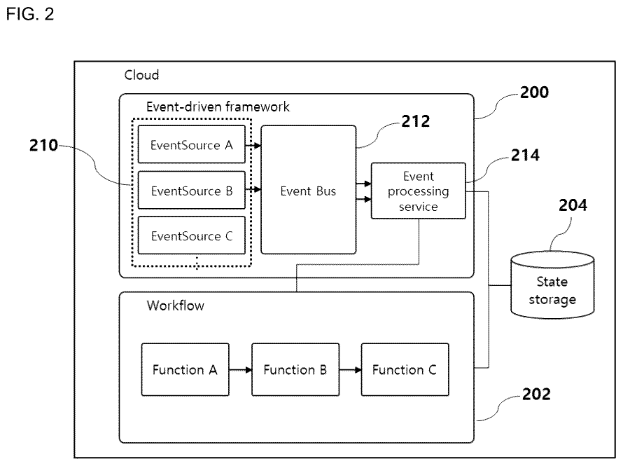

FIG. 2 is a diagram illustrating a FaaS platform for multi-event processing according to an embodiment of the present invention.

Referring to FIG. 2, the FaaS platform for multi-event processing according to this embodiment separates an event-driven framework 200 and a workflow 202 that includes the respective tasks (functions) to be performed and provides them in order to provide services corresponding to combinations of events input from a mobile network and general cloud events.

Here, the events may be received from a Network API, which is part of an ongoing telecommunication 5G network integration API project by the Linux Foundation.

The workflow 202 represents a flow of tasks that sets complex workflows of tasks, such as the order of tasks, serial/parallel task execution, and dependency settings, and can be defined as a combination of one or more functions.

The event-driven framework 200 is a platform that operates services based on events and may comprise an event source 210, an event bus 212, and an event processing service 214.

The event source 210 is a component that detects events input from a mobile network and events input from the cloud, converts them into a CloudEvents format, and delivers them. The event bus 212 serves as an intermediary to deliver the events received from the event source 210 to event consumers that subscribe to those events.

The event processing service 214 is a component responsible for multi-event processing among the event-subscribing consumers and is hereinafter also referred to as an event consumer.

The event-driven framework 200 comprises functions for detecting multiple events and delivering them to event consumers, and for determining whether a combination of subscribed multiple events satisfies preset conditions and executing the workflow 202. The workflow 202 executed through the event-driven framework 200 performs stepwise tasks.

Here, the conditions may comprise whether the multiple events are detected sequentially or in parallel, and the order of detection.

Tasks within the workflow 202, such as performing an action, waiting, or restarting according to a combination of multiple events, can be programmed and designed by a service developer or administrator to match the service being provided.

In addition, the FaaS platform according to this embodiment may further comprise a state storage 204.

The state storage 204 provides scalability for implementing various scenarios according to various combinations of events, such as guaranteeing the order of events between multiple events, waiting for individual workflow tasks, or restarting workflow tasks, which cannot be achieved through the basic combination of the event-driven framework 200 and the workflow 202.

According to this embodiment, a service provider (developer) only needs to develop functions, and the rest can be designed by the developer using the proposed system depending on the final service to be provided.

When workflow settings or updates occur according to event combinations, the functions deployed in the cluster and the independently programmable event-driven framework 200 and workflow 202 allow for easy application of changes or additions.

That is, when a subscribed event or its detection order changes, the functions within the workflow 202 can be modified according to the changed events and detection order.

The event-driven framework 200 detects events such as device location changes, network status changes, and task completion events transmitted from the Network API through the event source 210. It also detects general events, such as state changes in the state storage 204 or specific user actions, through the event source 210.

Among the event consumers responsible for multi-event processing, the event processing service 214 subscribes to the events to perform tasks using the events.

Here, the term “subscription” refers to monitoring specific events in the event-driven framework 200 in order to execute a service.

The event processing service 214 is programmed to determine which workflow 202 to execute based on a particular event combination and uses the state storage 204 to store information such as whether a subscribed event has been received and the status of each task within the workflow 202.

The state storage 204 stores information in a key-value pair data structure, such as information indicating that an event has been detected (event A: true) and information indicating that execution of a predetermined function within the workflow 202 has been completed (function A: true), and stores the above information based on the identification information of the event processing service 214.

The following describes various scenarios according to various event combinations and conditions.

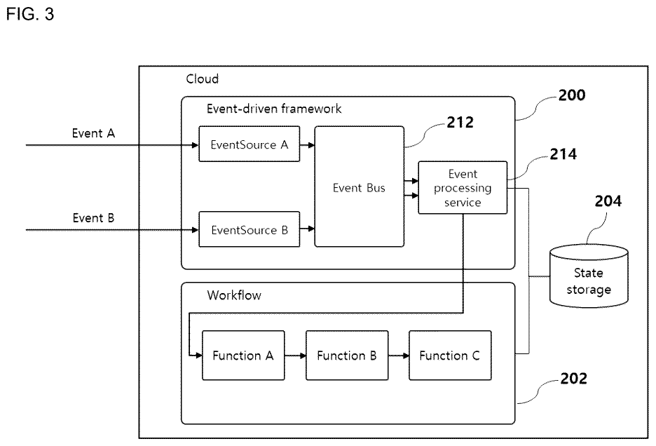

FIG. 3 is a diagram illustrating a first scenario according to an embodiment of the present invention.

FIG. 3 shows a case where events A and B satisfy the condition regardless of their order.

For example, the first scenario may involve sending a notification (function) when both a temperature rise (event A) and a humidity rise (event B) occur, or sending an SOS alert (function) when both a location change to a danger zone (event A) and the pressing of an emergency button (event B) occur.

Referring to FIG. 3, when events A and B are input to the event source 210, they are delivered to the event processing service 214 that subscribes to them.

The event processing service 214 determines that the programmed event combination and condition are satisfied and executes the workflow 202 that includes the predetermined tasks.

In the first scenario, since there is no need to guarantee the order of events and the workflow is executed based on the combination and conditions of events, the state storage 204 is not used.

Although the first scenario can be processed using existing methods, it is inefficient in terms of reusability because the logic must be newly created whenever the event combination changes (for example, satisfying both event A and event C) or when the tasks are changed (for example, changing the task to perform functions A, C, and C in that order upon satisfaction of events A and B).

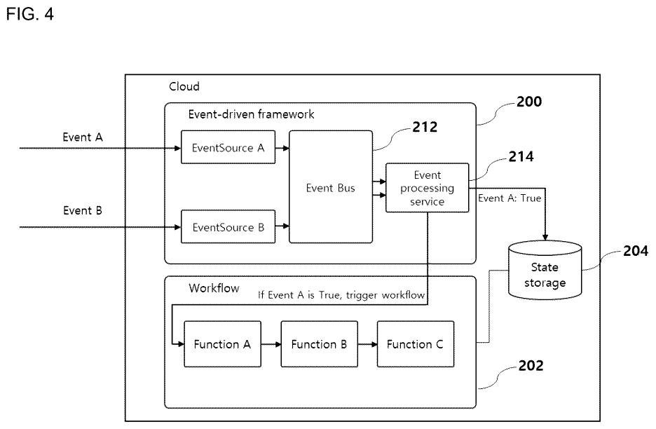

FIG. 4 Illustrates a Second Scenario According to the Present Embodiment.

The second scenario represents a situation in which event A should be detected first and event B should be detected sequentially for the workflow 202 to be executed—that is, a case in which the order of events must be guaranteed.

For example, in the second scenario, when a video is uploaded to storage, a thumbnail generation process is first completed (event A), and when the user's device changes its location to a specific place (a meeting room), the thumbnail is displayed (event B). To display the thumbnail, the thumbnail generation must precede it, and the condition that the user has moved to the meeting room must be satisfied.

Because the second scenario requires that the order of events be guaranteed, the state storage 204 is used.

Referring to FIG. 4, event A first occurs and is delivered to the event processing service 214 through the event source 210.

The event processing service 214 updates the state showing that event A has been input (event A: true) to the state storage 204.

Subsequently, when event B is input, it is delivered to the event processing service 214 through the event source 210. The event processing service 214 checks whether event A has already been input (event A: true) and, if the predefined event combination and conditions are met (event A && event B), executes the workflow 202.

If event B is input first, the workflow 202 cannot be executed because event A: true has not yet occurred.

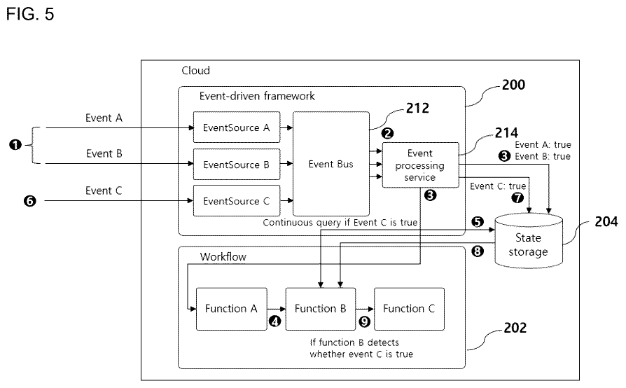

FIG. 5 illustrates a third scenario according to the present embodiment.

The third scenario is one in which events A and B are input simultaneously, triggering execution of tasks corresponding to the condition within the workflow 202, and when the subsequent event C is input, the next tasks are executed.

Referring to FIG. 5, the detailed execution process of the third scenario is as follows:
When events A and B are input (\textcircled{1}), they are transmitted through the event source 210 to the event processing service 214 (\textcircled{2}).
The event processing service 214 updates the states of the two events (event A: true, event B: true) to the state storage 204 and executes the workflow 202 (\textcircled{3}).
After the workflow 202 performs and completes the tasks (\textcircled{4}), it executes function B (\textcircled{5}) to check whether the next event has been received. Here, function B periodically checks in the state storage 204 whether event C: true.
When event C is input (\textcircled{6}), the event source 210 delivers it to the event processing service 214, which then updates the state storage 204 with the state (\textcircled{7}).
Function B queries the state storage 204, confirms that event C: true (\textcircled{8}), and, after completion of function B, proceeds to execute function C (\textcircled{9}).

In the third scenario, function B periodically checks whether the condition that event C has been input into the state storage 204 has been satisfied.

Additionally, a timeout for function B can be set within the workflow 202. This feature, provided by the workflow system, prevents the workflow from waiting indefinitely and can be configured according to the service provider's needs.

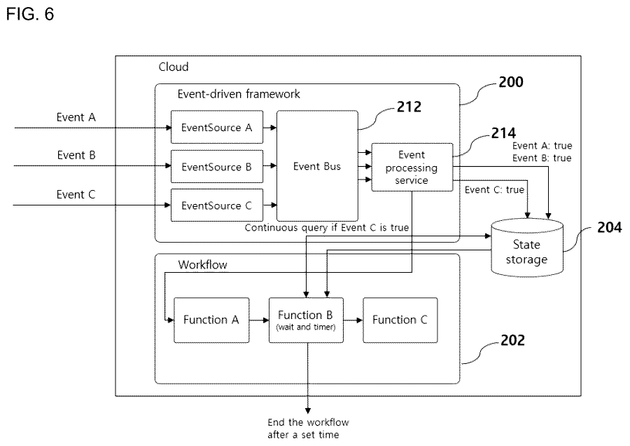

FIG. 6 illustrates an example where a timeout is set and a predetermined function fails to complete within the designated time.

As shown in FIG. 6, while performing functions according to a defined workflow, unexpected situations may occur, causing the workflow to terminate. In such cases, it may be necessary to restart the process from the function that was being executed when the issue occurred. Based on the state information of the workflow 202 stored in the state storage 204, it is possible to restart from the failed function.

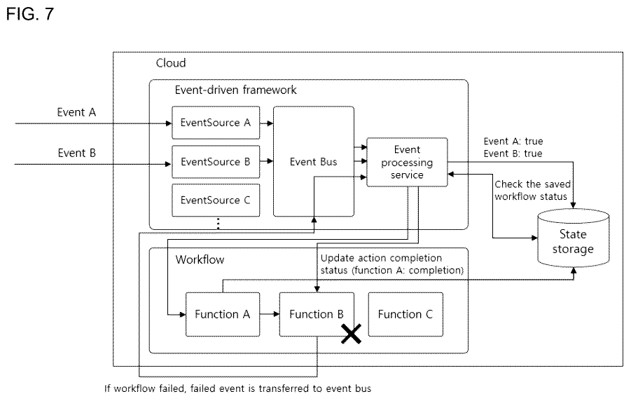

FIG. 7 illustrates a case in which a specific task within a suspended workflow is restarted.

Referring to FIG. 7, the case in which the workflow tasks corresponding to the combination of events A and B are being executed through the event processing service 214 is considered, as in the third scenario.

Each function, upon completion, uploads its task completion status to the state storage 204. For example, it is updated to function A: succeed and function A′ parameter: A.

If an unexpected situation causes the workflow to terminate abnormally, the function that was executing generates an abnormal termination event and delivers it to the event bus 212.

The event processing service 214, which subscribes to the abnormal termination event, receives the abnormal termination event and performs the corresponding action.

Then, function A checks the workflow completion status from the state storage 204 (in this case, function A: succeed), and the event processing service 214, based on the programmed condition (if function A: succeed, execution from function B), re-executes the workflow 202 from the corresponding function B.

The workflow-based FaaS method for multi-event processing described above can also be implemented as a computer-readable recording medium containing executable instructions, such as applications or program modules, that are executed by a computer. A computer-readable medium may be any available medium accessible by a computer and includes both volatile and non-volatile, removable and non-removable media. It may include computer storage media implemented in any method or technology for storing information such as computer-readable instructions, data structures, program modules, or other data.

The embodiments described herein are disclosed for illustrative purposes, and various modifications, changes, and additions can be made by those skilled in the art without departing from the spirit and scope of the invention. Such modifications, changes, and additions should be considered as falling within the scope of the following claims.

1. A Function as a Service (FaaS) platform for multi-event processing based on Kubernetes comprising:
an event-driven framework configured to detect events input from a mobile network and events input from a cloud, and to determine whether a combination of subscribed multiple events satisfies a preset condition;
a workflow configured to execute a series of functions for one of performing an action, waiting, and restarting according to the combination of the multiple events when the combination of the multiple events satisfies the preset condition; and
a state storage configured to store, based on identification information of an event consumer subscribing to a predetermined event, one of information about the detection of the predetermined event, information about completion of a predetermined function execution, information about execution of a predetermined function in the workflow, and information about abnormal termination of a predetermined function in the workflow.

2. The FaaS platform for multi-event processing of claim 1, wherein the event-driven framework comprises,
an event source for each event configured to detect and convert an event into a CloudEvents format, and deliver it;
an event bus configured to deliver the event input to the event source to an event consumer; and
an event processing service configured to determine whether a plurality of subscribed events delivered from the event bus satisfy a preset condition and to execute a predetermined function within the workflow.

3. The FaaS platform for multi-event processing of claim 1, wherein the event comprises a change in a location of a user device, a change in network status, and whether a predetermined task is completed.

4. The FaaS platform for multi-event processing of claim 1, wherein the condition comprises whether the multiple events are sequentially or in parallel detected and the order of detection.

5. The FaaS platform for multi-event processing of claim 1, wherein when a subscribed event is changed or an event detection order is changed, functions within the workflow are modified according to the changed event and detection order.

6. The FaaS platform for multi-event processing of claim 1, wherein a timeout is set for waiting in a predetermined function of the workflow, and the predetermined function is restarted when a next event is detected within the preset timeout period.

7. A Function as a Service (FaaS) apparatus for multi-event processing based on Kubernetes comprising:
a processor; and
a memory connected to the processor,
wherein the memory stores program instructions executed by the processor to:
detect events input from a mobile network and events input from a cloud, and determine whether a combination of subscribed multiple events satisfies a preset condition,
execute a series of functions for one of performing an action, waiting, and restarting according to the combination of multiple events when the combination of multiple events satisfies the preset condition, and
store, based on identification information of an event consumer subscribing to a predetermined event, one of information about detection of the predetermined event, information about completion of a predetermined function execution, information about execution of a predetermined function in the workflow, and information about abnormal termination of a predetermined function in the workflow.

8. A method for providing a Function as a Service (FaaS) service for multi-event processing based on Kubernetes comprising:
detecting, by an event-driven framework, events input from a mobile network and events input from a cloud, and, and determining whether a combination of subscribed multiple events satisfies a preset condition;
executing, by a workflow, a series of functions for one of performing an action, waiting, and restarting according to the combination of multiple events when the combination of multiple events satisfies the preset condition; and
storing, by a storage, based on identification information of an event consumer subscribing to a predetermined event, one of information about detection of the predetermined event, information about completion of a predetermined function execution, information about execution of a predetermined function in the workflow, and information about abnormal termination of a predetermined function in the workflow.

9. The method of claim 8, wherein the determining comprises,
detecting an event through an event source for each event, converting the event into a CloudEvents format, and delivering it;
delivering the event input to the event source to an event consumer through an event bus; and
determining, through an event processing service, whether a plurality of subscribed events delivered from the event bus satisfy a preset condition and executing a predetermined function within the workflow.

10. The method of claim 8, wherein the event comprises a change in a location of a user device, a change in network status, and whether a predetermined task is completed.

11. The method of claim 8, wherein the condition comprises whether the plurality of events are sequentially or in parallel detected and the order of detection.

12. The method of claim 8 further comprises,
modifying, when a subscribed event is changed or an event detection order is changed, functions within the workflow according to the changed event and detection order.
